(19) United States
(12) Patent Application Publication
(10) Pub. No.: US 2005/0043084 A1
(43) Pub. Date: Feb. 24, 2005

(54) Symbol display device for game machine

(75) Inventor: Haruo Inoue, Tokyo (JP)

Correspondence Address: YOUNG & THOMPSON, 745 SOUTH 23RD STREET, 2ND FLOOR, ARLINGTON, VA, 22202, US

(73) Assignee: DRAGON CO., LTD., TOKYO (JP)

(21) Appl. No.: 10/751,475

(22) Filed: Jan. 6, 2004

(30) Foreign Application Priority Data
Aug. 22, 2003 (JP) 2003-298229

(51) Int. Cl. A63F 13/00

(52) U.S. Cl. 463/20; 273/143 R

(57) ABSTRACT

A first, a second, and a third reel units consist of an inner and an outer reels respectively. A symbol “target” disposed in the outer reel forms a composite symbol by overlaying the symbol “target” on the symbol in the inner reel. The symbol “target” is related to win. When a normal game is started, the inner reel rotates in a normal direction, and the outer reel starts to rotate in the normal and a reverse directions in order to fluctuate the symbol “target” between an upper and an lower portions of a display window. Thereafter, the inner reel stops, and then the outer reel stops after a predetermined time. The player wins the game when the same symbols are aligned in a row in winning lines, or when the same composite symbol is displayed in the first, the second, and the third lines respectively.

### BACKGROUND OF THE INVENTION

1. Field of the Invention

The present invention relates to a symbol display device, which displays win or loss of a game according to combinations of symbols in a symbol display window, used for a game machine, such as a slot machine, a pachinko machine, and the like.

2. Background Arts

Many game machines such as a slot machine and a pachinko machine have a symbol display device using plural reels. Each reel is arranged with plural types of symbols on the outer periphery thereof, and rotates inside a symbol display window. If a winning symbol combination is obtained when the reels stop the rotation, a player wins the game. Then, the slot machine pays out a predetermined number of prize coins to the player. The pachinko machine offers a bonus to a player in the game.

Various changes have been made to improve the symbol display device in order to attract and sustain the player's interest. Byway of example, there is a symbol display device which rotates the reels in normal and reverse directions repeatedly in a very short time when the win is determined (for instance, U.S. Pat. No. 5,609,524). Such performance of winning is strongly appealing to the player. However, it could not attract the player's interest effectively, since the above performance is carried out only after the win is determined.

There is a symbol display device with a double reel structure having inner and outer reels (for instance, U.S. Pat. No. 5,395,111). Such symbol display device displays a composite symbol in the symbol display window by overlaying the symbol in the outer reel on the symbol in the inner reel. As a result, the symbol display device becomes effective means for providing the player the expectation of the win by increasing the types of symbols and winning symbol combinations. However, the device is not able to provide sufficient appeal to the player even though it has a unique structure (a double reel structure), since the game contents does not vary from conventional ones.

### SUMMARY OF THE INVENTION

An object of the present invention is to provide a symbol display device, which can raise a player's expectations for a win, by taking advantage of the characteristics of the double reel structure.

To achieve the above object, a symbol display device according to the present invention includes plural reels having plural zones and plural types of symbols. One of the plural zones is a win/loss determining zone consisting essentially of a winning symbol and non-symbol area. At least one of the plural reels is double reels including an inner reel and a transparent outer reel to form a composite symbol by combination with a winning symbol disposed in a first reel that is one of the outer and inner reels and a symbol provided on a second reel that is the other reel, and a controller controls the first reel to stop rotation after repeating the rotation in the normal and the reverse directions within a range that the winning symbol is displayed in the display window before win or loss of the game is determined. The second reel is stopped after the first reel is stopped. The reels may be stopped in a reverse order. Further, the winning symbol may be provided in the second reel. In that case, the controller stops the second reel after repeating the rotation in the normal and the reverse directions within a range that the winning symbols are displayed in the display window. The controller controls the rotation of the first reel such that only one of the plural zones is displayed through the display window, and changes a zone to be displayed in the display window according to a game stage.

The symbol display device according to the present invention also includes a decoration symbol provided in the first reel. The controller rotates the first reel to overlay the decoration symbol on the winning symbol provided on the second reel after the win is decided. The decoration symbol is not displayed while the first reel repeats the rotation in the normal and the reverse directions.

The symbol display device according to the present invention further includes a shielding symbol, which is disposed in the outer reel and shields a part of a symbol disposed in the inner reel. The shielding symbol is not displayed in the display window while the first reel repeats the rotation in the normal and the reverse directions.

According to the present invention, the player has two steps of expectations of the win: the first expectation depends on the stop position of the first reel, and the second expectation depends on the stop position of the second reel. Thereby, the expectation of the win is increased to attract player's interest. Further, the game offers an effective performance by providing the decoration symbol. Furthermore, the variety of the game is increased by providing the shielding symbol.

### BRIEF DESCRIPTION OF THE DRAWINGS

The above and other objects and advantages of the present invention will become apparent from the following detailed description of the preferred embodiment when read in association with the accompanying drawings, which are given by way of illustration only and thus are not limiting the present invention. In the drawings, same reference numerals designate like or corresponding parts throughout the several views, and wherein:

FIG. 1 is an external view of a slot machine incorporated with a symbol display device;

FIG. 2 is an explanatory view of winning lines;

FIG. 3 is an external view of inner and outer reels;

FIG. 4 is a plan view of a symbol sheet and a transparent sheet;

FIG. 5 is an explanatory view showing a composite symbol;

FIG. 6 is an explanatory view showing a symbol “HIT” decorating another symbol;

FIG. 7 is an explanatory view showing a symbol “SNIPER SHOT” shielding another symbol;

FIG. 8 is a block diagram showing electrical configuration of a slot machine;

FIG. 9 is a flow chart showing a game process;

FIG. 10 is an explanatory view showing a movement of a symbol “target”;

FIG. 11 is an explanatory view showing a winning combination of composite symbols;

FIG. 12 is an explanatory view showing the symbol “HIT” decorating winning symbols;

FIG. 13 is an explanatory view showing a start of a special game;

FIG. 14 is an explanatory view showing an end of the special game;

FIG. 15 is a front view of a pachinko machine incorporated with the symbol display apparatus;

FIG. 16 is an explanatory view showing the winning Lines; and

FIG. 17 is an explanatory view showing the transparent Sheet.

### DETAILED DESCRIPTION OF THE EMBODIMENTS

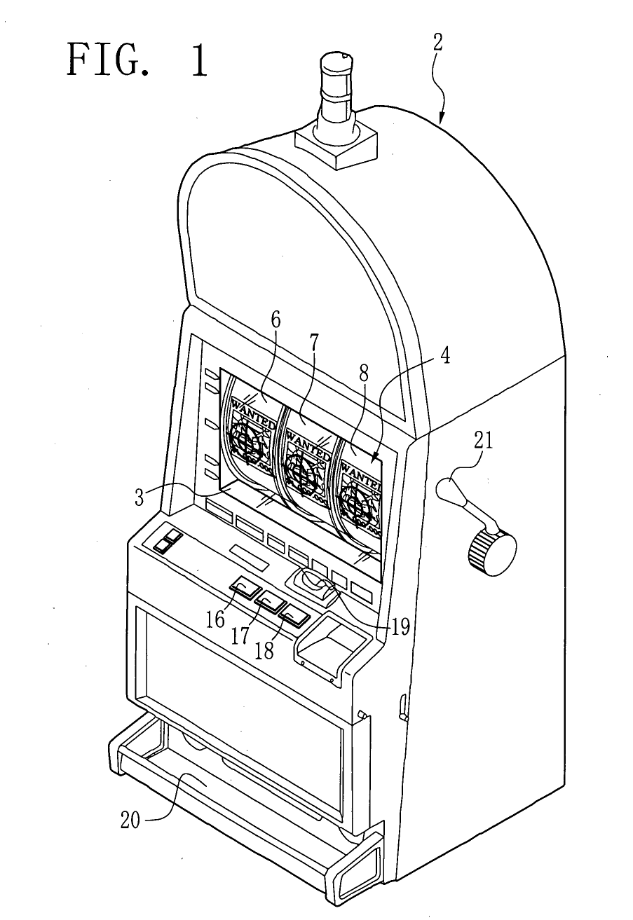

Referring to FIG. 1, a display window 3 is formed in the front center portion of a slot machine 2. A first reel unit 6, a second reel unit 7, and a third reel unit 8, which are included in a symbol display device 4 of a mechanical reel type, are observed from the display window 3. A bet button 16, a MAX bet button 17, a pay out button 18, and a coin slot 19 are provided in a lower portion of the display window 3.

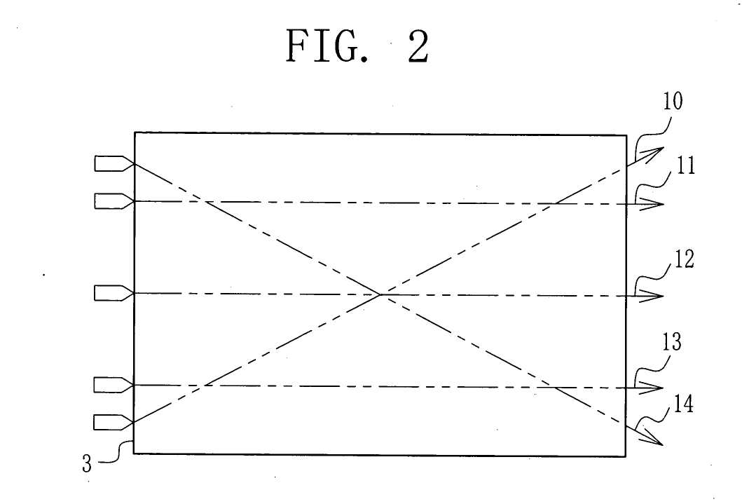

Referring to FIG. 2, there are five winning lines 10-14 that consist of three horizontal and two oblique lines across the display window 3. A player inserts the coin through the coin slot 19, and bets the coin by pressing the bet button 16 or the MAX bet button 17. The winning lines 10-14 become effective according to the number of inserted coins. The player can also bet the coins accumulated in a credit counter (not shown), in addition to the coins actually inserted through the coin slot 19. Medals and tokens can also be used as the coins.

A start lever 21 is provided on the side of the slot machine 2. When the start lever 21 is operated after the coins are bet, the first, the second, and the third reel units 6-8 start to rotate. After a predetermined time, the first, the second, and the third reel units 6-8 stop. The win or the loss in the game is determined according to the combinations of the symbols displayed in the display window 3. When the player wins the game, a predetermined number of dividend coins according to the type of the winning combination is obtained. The dividend coins are paid out in the outlet 20 when the payout button 18 is pressed.

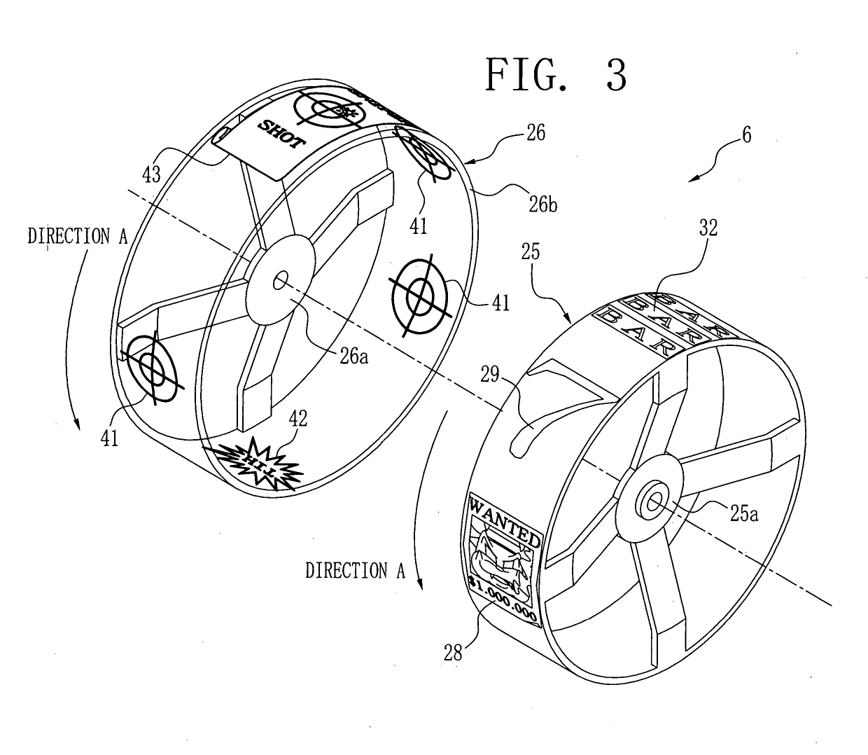

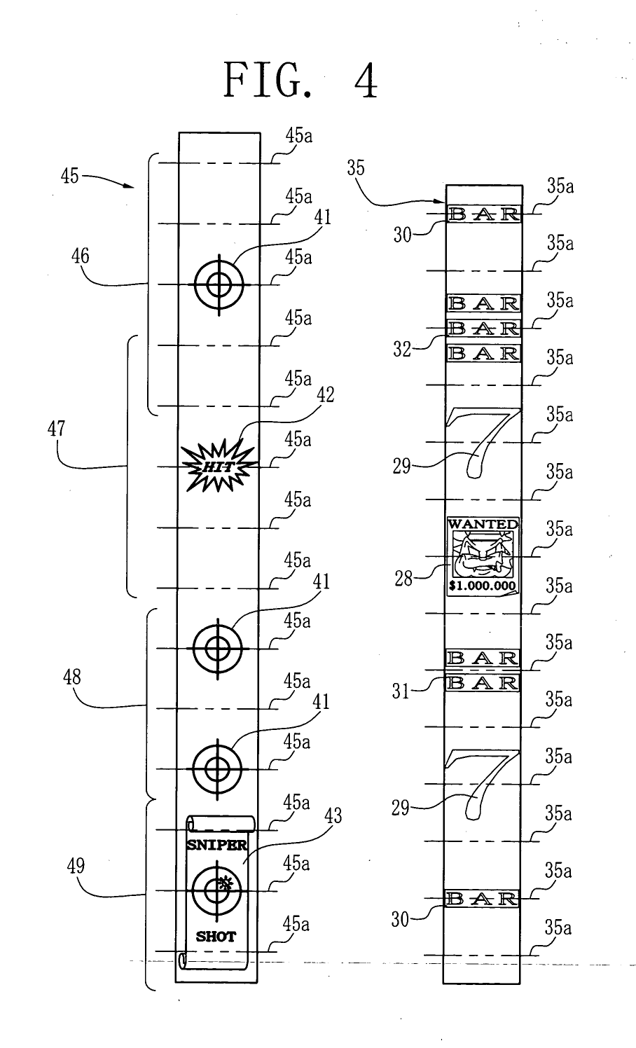

Referring to FIG. 3 and FIG. 4, the first, the second, and the third reel units 6-8 have the double reel structure that consists of an inner reel 25 and an outer reel 26 respectively. Since the first, the second, and the third reel units 6-8 have the same structure, the first reel unit 6 is used as an example in the following description.

The inner reel 25 is made of durable plastic material, and the whole outer periphery thereof is, for instance, white and opaque. A symbol sheet 35 is wrapped around the outer peripheral surface of the inner reel 25A. A symbol “WANTED” 28, a symbol “7” 29, a symbol “BAR” 30, a symbol “2 BAR” 31, and a symbol “3 BAR” 32 are printed in the symbol sheet 35.

The symbols 28-32 printed in the symbol sheet 35 are disposed on every other stop lines 35a, which have constant spacing. The stop lines 35a without the symbols are blank sections. Therefore, the stop line 35a with the symbol and that without the symbol are disposed alternately in the inner reel 25. Note that the stop lines 35a are imaginary lines and provided only for showing symbol positioning, and therefore, the stop lines 35a are not visually identified through the display window 3.

When the game is started, the inner reel 25 starts to rotate in a direction that the symbols move downward when viewed from the display window 3. (See FIG. 3, direction A. Hereinafter, direction A is referred to as a normal direction.) The inner reel 25 stops in a position where each of winning lines 11-13 overlay with the stop line 35a. Each symbol has adjacent blank sections. Accordingly, when the inner reels 25 of the first, the second, and the third reels 6-8 stop, three to six symbols are displayed in the display window 3.

An outer reel frame 26b, which is the outer peripheral surface of the outer reel 26, is made of transparent plastics. A transparent sheet 45, in which a symbol “target” 41, a symbol “HIT” 42, and a symbol “SNIPER SHOT” 43 are printed, is wrapped around the outer peripheral surface of the outer reel 26.

As with the symbol sheet 35, each of the symbols 41-43 printed in the transparent sheet 45 is placed on the stop line 45a. The area in which the corresponding stop line does not intersect the symbols is transparent blank section. The sizes of the blank sections depend on the placed symbols, which is described later. Since the blank sections are transparent, the player can observe the symbols on the inner reel 25 through the clearance of each symbol or through the blank sections in the outer reel 26. Note that the stop line 45a is an imaginary line provided only showing symbol positioning. The player cannot visually identify the stop lines 45a through the display window 3.

When the game is started, the outer reel 26 stops in a position, where the winning lines 11-13 and the stop lines 45a with the symbols overlay with each other, after predetermined pattern of rotation. Therefore, the symbols are always displayed in the display window 3 when the outer reel 26 is stopped.

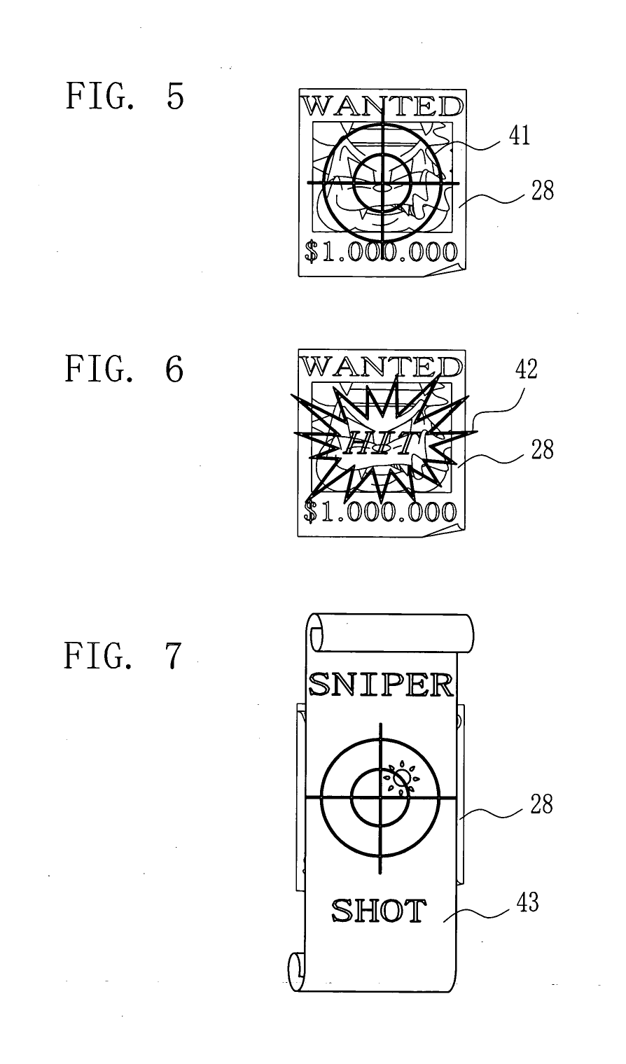

The symbol “target” 41 is a winning symbol. Referring to FIG. 5, a composite symbol is formed by overlaying the symbol “target” 41 on the symbol in the inner reel 25. The composite symbol relates to the win. FIG. 5 shows an example of overlaying the symbol “target” 41 on the symbol “WANTED” 28. In this embodiment, 5 types of symbols are disposed in the inner reel 25, so that it is possible to form 5 types of composite symbols by overlaying the symbol “target” 41 on each symbol in the inner reel 25.

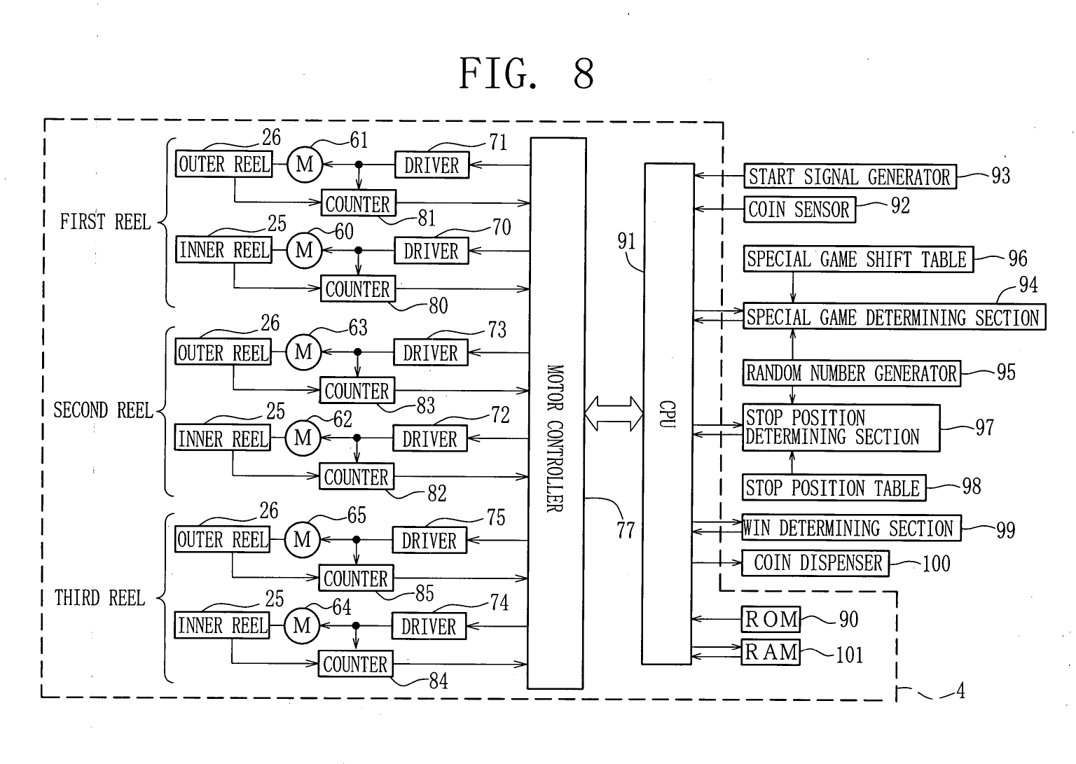

The symbol “HIT” 42 is a decoration symbol. Referring to FIG. 6, the symbol “HIT” 42 decorates the symbol in the inner reel 25 by overlaying the symbol “HIT” 42 on the symbol in the inner reel 25. The symbol “SNIPER SHOT” 43 is a shielding symbol, drawn with a light-shielding coating. Referring to FIG. 7, the symbol “SNIPER SHOT” 43 shields the symbol in the inner reel 25 by overlaying the symbol “SNIPER SHOT” 43 on the symbol in the inner reel 25. As a result, the player cannot observe the symbols in the inner reel 25.

The transparent sheet 45 has A zone 46, B zone 47, C zone 48, and D zone 49, and A to D zones 46-49 are used according to the game stage.

The A zone 46 is formed of the symbol “target” 41 and two blank sections that are placed above and below the symbol “target” 41. Each blank section includes two stop lines 45a. The A zone 46 is used in the normal game and in a special game which is described later. The symbol “target” 41 in the A zone 46 is displayed in the center of the display window 3 at the start and at the end of the game. (See FIG. 1)

The B zone 47 is formed of the symbol “HIT” 42 and two blank sections that are placed above and below the symbol “HIT” 42. Each blank section includes two stop lines 45a. The B zone 47 is used when the win is determined. The A zone 46 and the B zone 47 shares the blank section formed between the symbol “target” 41 and the symbol “HIT” 42.

The C zone 48 and the D zone 49 are used in the special game which occurs with a predetermined probability during the normal game. The C zone 48 is formed of a blank section including a stop line 45a and two symbols “target” 41 that are placed above and below the blank section. The D zone 49 is formed of the symbol “SNIPER SHOT” 43 which spans three stop lines 45a.

Attachment plates 25a and 26a are integrally formed with the inner and the outer reels 25 and 26 respectively. The inner and the outer reels 25 and 26 are connected to stepping motors through attachment plates 25a and 26a. The inner and the outer reels 25 and 26 rotate according to the rotation of the stepping motors.

FIG. 8 is a block diagram showing the outline of electrical configuration of the slot machine 2. Stepping motors 60-65, which rotate the inner and the outer reels 25 and 26 of the first, the second, and the third reels 6-8, are connected to and driven by a motor controller 77 through drivers 70-75. The motor controller 77 supplies drive pulses to the stepping motors 60-65 through the drivers 70-75. As the stepping motors 60-65 rotate in steps of a predetermined angle according to the number of the drive pulses input through the drivers 70-75, the inner and the outer reels 25 and 26 rotate accordingly.

Counters 80-85 count the number of the drive pulses input in the stepping motors 60-65 through the drivers 70-75. Each of the inner and the outer reels 25 and 26 is provided with a guide mark for indicating a reference position, and photo interrupters observe the rotation of the inner and outer reels 25 and 26. Whenever the inner and outer reels 25 and 26 make one round, the photointerrupters output a reset signal in order to reset the counted values in the counters 80-85. Thus, the counted values in the counters 80-85 indicate the rotational positions of the inner and the outer reels 25 and 26 within one round.

The rotational positions, and the types and the arrangements of the symbols in the inner and the outer reels 25 and 26 when the reset signal is obtained are known in advance. A ROM 90 stores a data table, which defines correspondences between the types of the symbols disposed in the inner and the outer reels 25 and 26 and the number of the steps required for moving the symbols from the reference position to the stop lines 35a and 36a. In addition, the data table stores information of stop lines 35a and 45a that correspond to symbols displayed in the display window 3 when the inner and the outer reels 25, 26 are placed in the reference positions respectively. Therefore, it is possible to control the positions of the symbols that appear in the display window 3 by adjusting the number of drive pulses supplied to the stepping motors 60-65 while referring to the counters 80-85.

A CPU 91 is connected to each section of the slot machine 2 to control the operation of each section. The CPU 91 is operated according to a control program which is stored in the ROM 90. The CPU 91 controls the motor controller 77. The CPU 91 also controls rotation, stop, rotation pattern, and the stop position of the inner and the outer reels 25 and 26.

A coin sensor 92 is provided behind the coin slot 19, and inputs a coin detection signal in the CPU 91 each time the inserted coin is detected. The CPU 91 activates the winning lines 10-14 in sequence each time the coin detection signal is input. The activated winning lines are temporarily stored in the RAM 101. When the start lever 21 is operated after the coins are inserted, a start signal generator 93 turns on to output a game start signal from the CPU 91 to a special game determining section 94.

The special game determining section 94 activates a random number generator 95 to carry out a random number sampling when the special game determining section 94 receives the game start signal from the CPU 91. The special game determining section 94 determines whether to shift to the special game according to the sampled random number and a special game shifting table 96. When it is determined to start the special game, a special game start signal is output to the CPU 91 and to a stop position determining section 97. When it is determined not to shift to the special game, a normal game start signal is output to the CPU 91 and to the stop position determining section 97.

When the normal game start signal is input, the stop position determining section 97 determines stop positions of the inner and the outer reels 25 and 26. The stop position determining section 97 activates the random number generator 95 to carry out the random number sampling. A stop position table 98 stores a data table, in which the random number corresponds to the stop position of each reel. The stop position determining section 97 determines the stop positions of the inner and outer reels 25 and 26 according to the sampled random number and the stop position table 98. Thereby, the types of the symbols to be displayed in the display window 3 and the winning lines to display the symbols are determined. The stop position determining section 97 temporarily stores the determined stop positions of the inner and outer reels 25,26 in a RAM 101.

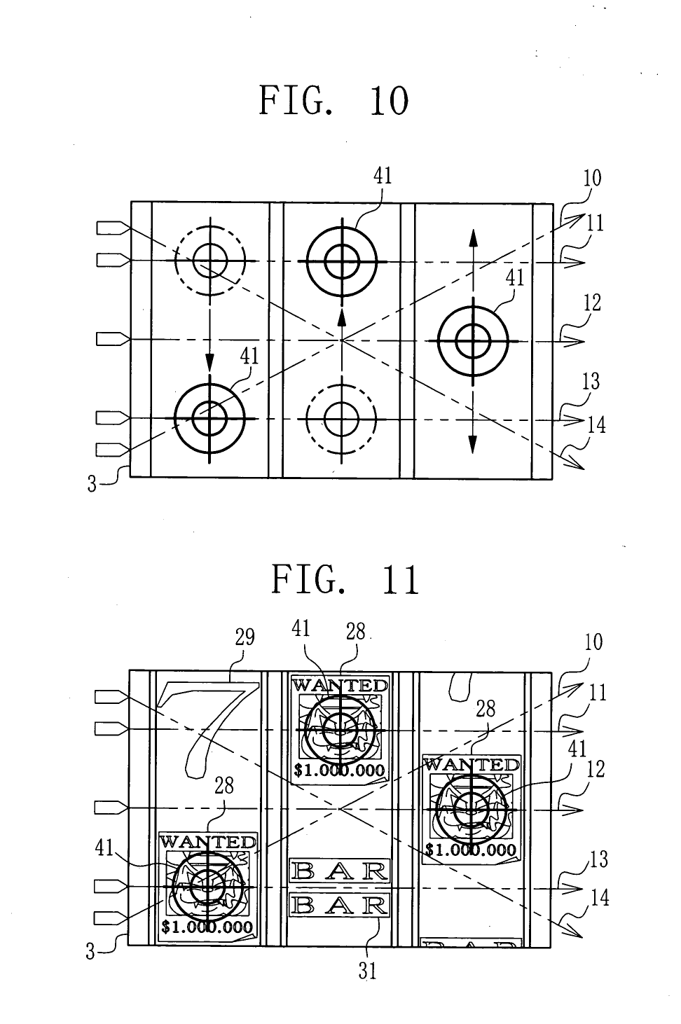

When the normal game start signal is input, the CPU 91 drives the motor controller 77 to rotate the inner reel 25 in the normal direction. The CPU 91 also rotates the outer reel 26 in the normal direction until the symbol “target” 41 in the A zone 46 is displayed on the winning line 13 in the lower portion of the display window 3 while referring to the counted values in the counters 81, 83, and 85. Thereafter, the CPU 91 rotates the outer reel 26 in the reverse direction, which is the opposite direction to the normal direction, until the symbol “target” 41 is displayed on the winning line 11 in the upper portion of the display window 3. The outer reel 26 carries out the rotation in the normal and in the reverse directions repeatedly (See FIG. 10).

After a predetermined time, the CPU 91 outputs a reel stop signal to the motor controller 77 to stop each reel after rotating each reel to the stop position stored in the RAM 101 while referring to the counted values in the counter 80-85 and the data table which is stored in the ROM 90. The inner reel 25 is stopped at first, and then the outer reel 26 is stopped after a predetermined time.

The stop position determining section 97 only determines the stop position of the inner reel 25 when the special game start signal is input. The random number generator 95 carries out the random number sampling. The stop position determining section 97 determines the stop position of the inner reel 25 according to the sampled random number and the stop position table 98. Then, the determined stop position is temporarily stored in the RAM 101.

When the special game start signal is input, the CPU 91 rotates and stops the outer reel 26 to display the symbol “SNIPER SHOT” 43, which is disposed in the D zone 49, in the center of the display window 3 while referring to the counted values in the counter 81, 83, and 85 (See FIG. 13). Thereafter, the CPU 91 rotates the inner reel 25 in the normal direction. After a predetermined time, the CPU 91 outputs the reel stop signal to the motor controller 77 to stop the inner reel 25 in the stop position stored in the RAM 101.

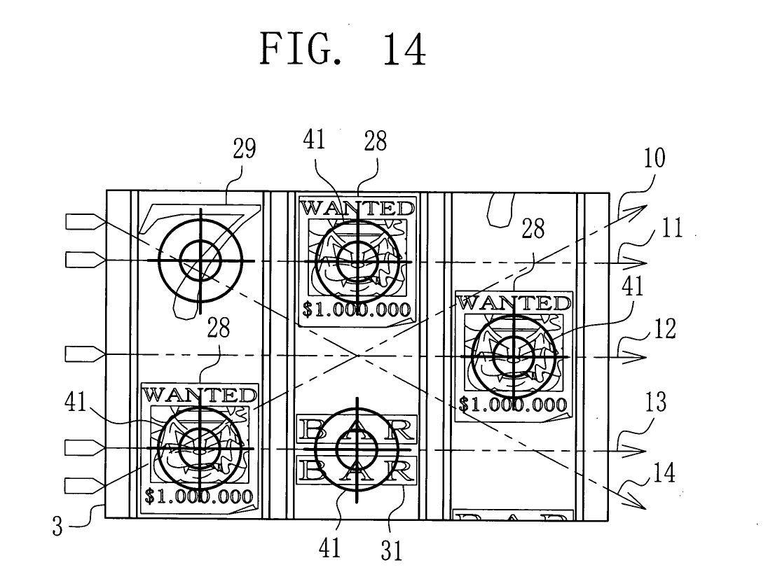

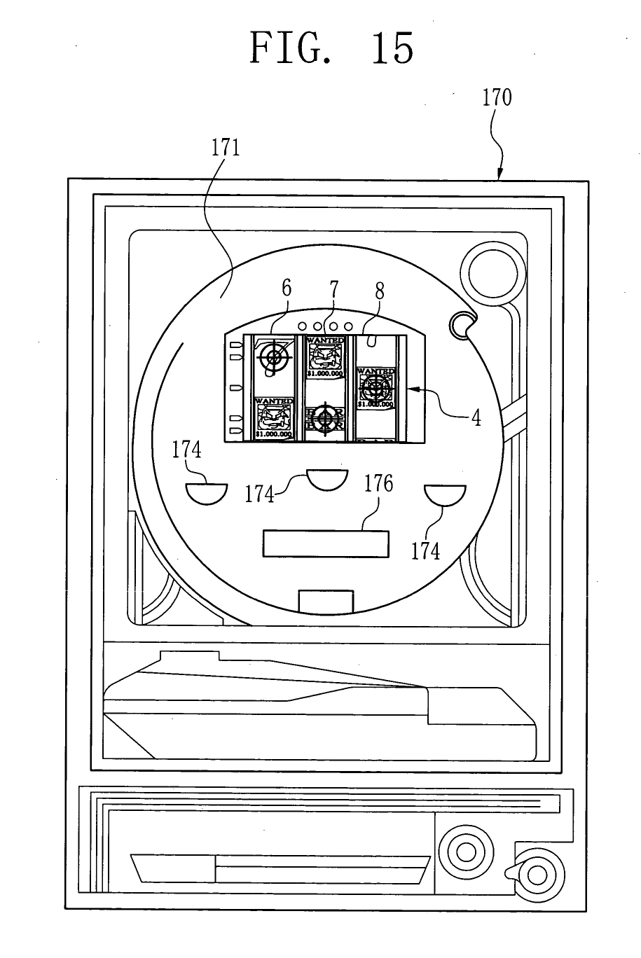

Referring to the counted values in the counters 80, 82, and 84, the CPU 91 checks the stop positions of the inner reel 25. Then, the CPU 91 determines the stop positions of the outer reel 26 to overlay the symbols “target” 41 on all symbols in the inner reel 25 that are displayed in the display window 3 (See FIG. 14). There are two patterns in displaying the symbols of the first, the second, and the third reel units 6-8. One of the patterns is displaying two symbols on the winning lines 11 and 13 respectively, and the other is displaying one symbol on the winning line 12. In the former, the C zone 48 is used. In the latter, the A zone 46 is used. The CPU 91 drives the motor controller 77 to rotate the outer reel 26. Thereafter, the CPU 91 stops the outer reel 26 in the determined stop position by outputting the reel stop signal.

A win determining section 99 determines whether the displayed combinations of the symbols or the composite symbols match the predetermined winning combinations stored in the ROM 90 when the normal and the special games are completed and the inner and the outer reels 25 and 26 are stopped. The win determining section 99 checks the stop positions of all reels to see if there are any winning symbol combinations while referring to the counters 80-85.

When the win determining section 99 determines the win, the CPU 91 rotates the outer reel 26 until the symbol “HIT” 42 in the B zone 47 overlays on the winning symbol (See FIG. 12). When the win is determined, the CPU 9; activates a coin dispenser 100 to pay out the number of coins according to the winning symbol combination. Thereafter, the CPU 91 rotates the outer reel 26 until the symbol “target” 41 in the A zone 46 is displayed in the center of the display window 3 (See FIG. 1).

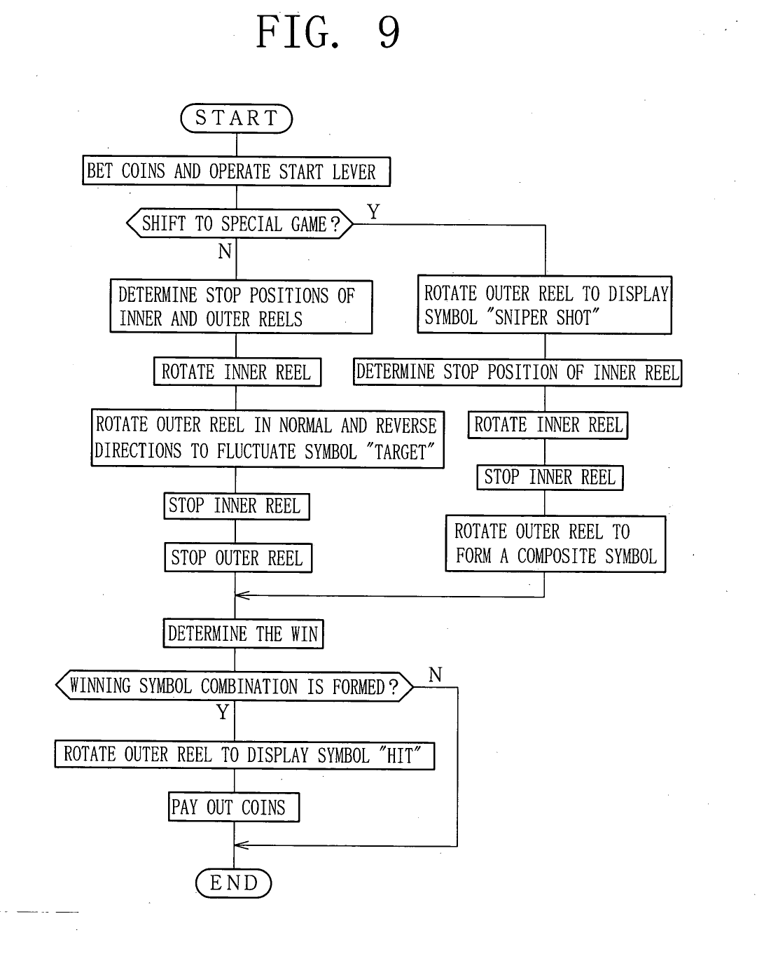

The operation of the above configuration is described in the following while referring to the flow chart of FIG. 9. The player inserts a predetermined number of coins through the coin slot 19, and bets the coins by pressing the bet button 16 or the MAX bet button 17. The winning lines 10-14 become effective according to the number of inserted coins. The player can start the game by operating the start lever 21.

At the start of the game, whether to start the normal game or the special game is determined by a lottery. The following description describes steps of the normal game and the special game respectively. Note that all winning lines 10-14 are activated in the following games.

When the normal game is started, the stop positions of the inner and the outer reels 25 and 26 of the first, the second, and the third reel units 6-8 are determined by the lottery. Then, the inner reels 25 start to rotate in the normal direction, and the outer reels 26 rotate in the normal and the reverse directions to fluctuate the symbols “target” 41, which are disposed in the A zones 46, between the upper and the lower portions of the display window 3. Thereafter, the inner reels 25 stop, and then the outer reels 26 stop after a predetermined time. Note that the symbols disposed in the other zone of the outer reel 26 are not observed from the display window 3 during the rotation of the outer reel 26, because the symbol “target” 41 is interposed between the blank sections in the A zone 46.

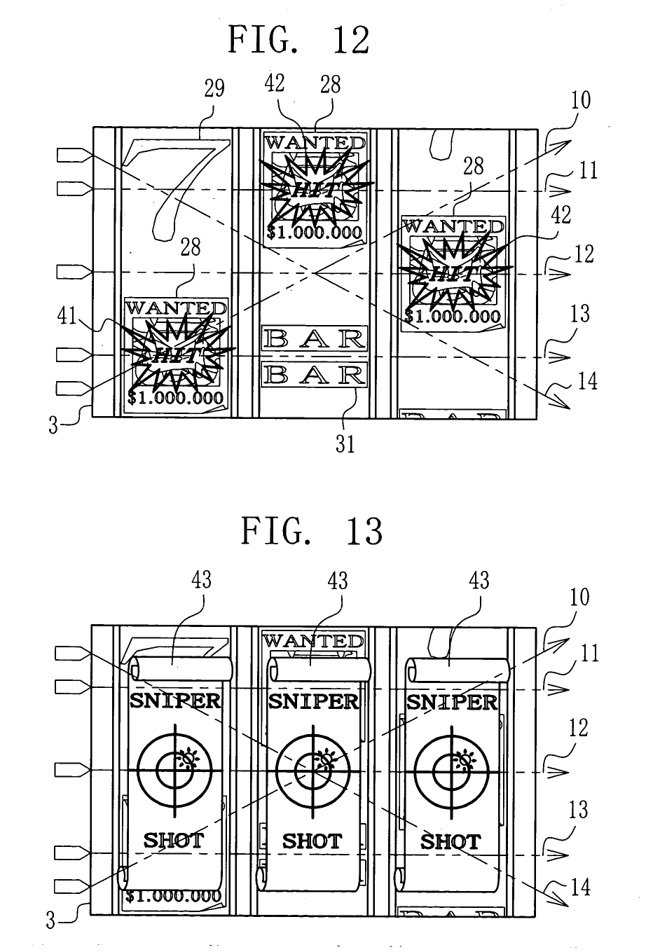

The win or the loss of the game is determined after each reel is stopped. The symbols in the inner reel 25 are related to the win. The player wins the game when the same symbols are aligned in a row in one of the winning lines 10-14. The symbol “target” 41 is a winning symbol. Further, a composite symbol formed by overlaying the symbol “target” 41 on the symbol of the inner reel 25 is also related to the win. The player also wins the game when the same composite symbol appears in the first, the second, and the third reel units 6-8 respectively (See FIG. 11).

When the player wins the game, the outer reels 26 rotate to show a performance by decorating the winning symbols. At that time, the B zone 47 of the outer reel 26 is used. Referring to FIG. 12, the outer reel 26 rotates until the symbol “HIT” 42 in the B zone 47 is overlaid on the winning symbol displayed in the display window 3, and then stops. As with the A zone 46, the blank sections are provided above and below the symbol “HIT” 42 in the B zone. Therefore, no matter where the symbol “HIT” 42 is displayed in the display window 3, other symbols on the outer reel 26 are not observed from the display window 3.

After the above performance, the predetermined number of dividend coins is paid out in the outlet 20 according to the type of the winning symbol combination. Thereafter, the outer reel 26 rotates until the symbol “target” 41 in the A zone 46 is displayed in the center of the display window 3, and then stops.

When the special game is started, each outer reel 26 of the first, the second, and the third reel units 6-8 rotates until the symbol “SNIPER SHOT” 43, which is disposed in the D zone 49, is displayed in the center of the display window 3 to shield the symbol in the inner reel 25, and then stops (See FIG. 13).

When the outer reels 26 stop, the stop positions of the inner reels 25 of the first, second, and the third reel units 6-8 are determined by the lottery. The inner reels 25 start to rotate in the normal direction, and stop after a predetermined time. When the inner reels 25 stop, the outer reels 26 start to rotate again. At that time, the A zones 46 or the C zones 48 in the outer reels 26 are used according to the number of the symbols in the inner reels 25 aligned in the winning lines. Referring to FIG. 14, the outer reels 26 rotate until the symbols “target” 41 are overlaid on all symbols in the inner reels 25 that are displayed in the display window 3, and then stop.

The win or the loss is determined after each reel is stopped. As with the normal game, the win is obtained when the same symbols are aligned in a row in the winning lines 10-14, or when the same composite symbol is displayed in the first, the second, and the third reel units 6-8 respectively. In the special game, all symbols displayed in the display window 3 are composite symbols, so the probability of the win increases compared to the normal game.

When the win is obtained in the special game, the performance is shown by rotating the outer reels 26 to overlay the symbols 42 “HIT” in the B zone 47 on the winning symbols for decoration (See FIG. 12). Then, a predetermined number of dividend coins according to the winning symbol are paid out in the outlet 20. Thereafter, the outer reels 26 rotate to display the symbols “target” 41, which is disposed in the A zone 46, in the center of the display window 3.

Thus, in the normal game of the slot machine 2, the outer reels 26 rotate to fluctuate the symbols “target” 41 between the upper and the lower portions of the display window 3 after the inner reels 25 are stopped. As a result, the player has two steps of expectations of the win: a first expectation of the win based on the stop positions of the inner reels 25, and a second expectation of the win based on the stop positions of the outer reels 26. As a result, the expectation of the win is increased to raise the player's interest.

In addition, the symbol “SNIPER SHOT” 43 is provided in the outer reel 26 to shield the symbol in the inner reel 25 in order to increase the variety of the games. Further, the games are effectively performed by providing the symbol “HIT” 42 in the outer reel 26 for decoration.

In the above embodiment, the symbol display device is incorporated in the slot machine; however, it is also possible to incorporate the symbol display device in other game machines, such as the pachinko machine. Referring to FIG. 15, the same symbol display device 4 as the present invention is incorporated at the back of a display window 172 formed in the approximate center of a front board 171 in the pachinko machine 170. Note that the same numerals as the above embodiment are assigned to the equivalent members in FIGS. 15-17.

In case of the pachinko machine 170, the first, the second, and the third reel units 6-8 start to rotate, for instance, when balls are dropped in specific openings of prize openings 174 provided in the front panel 171. The win is obtained according to the combinations of the symbols or the composite symbols when the first, the second, and the third reels 6-8 are stopped. When the win is obtained, the pachinko machine 170 shifts its game mode from normal game mode to prize game mode. In prize game mode, attackers 176 open and close repeatedly for a predetermined time at a given number of times, so it becomes possible to obtain a large number of prize balls when the balls are dropped in the attackers 176.

For that reason, the player pays a close attention to the movement of each reel. As with the slot machine 2, the player has two steps of expectations of the win. The special game is also carried out with the symbols in the inner reels shielded, and the winning symbols decorated.

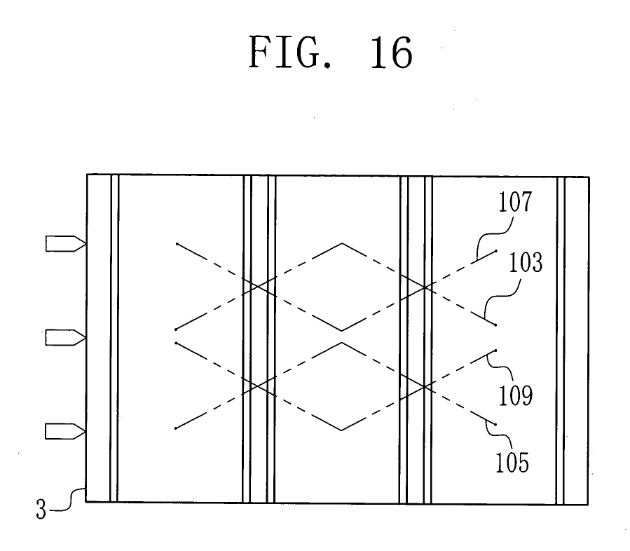

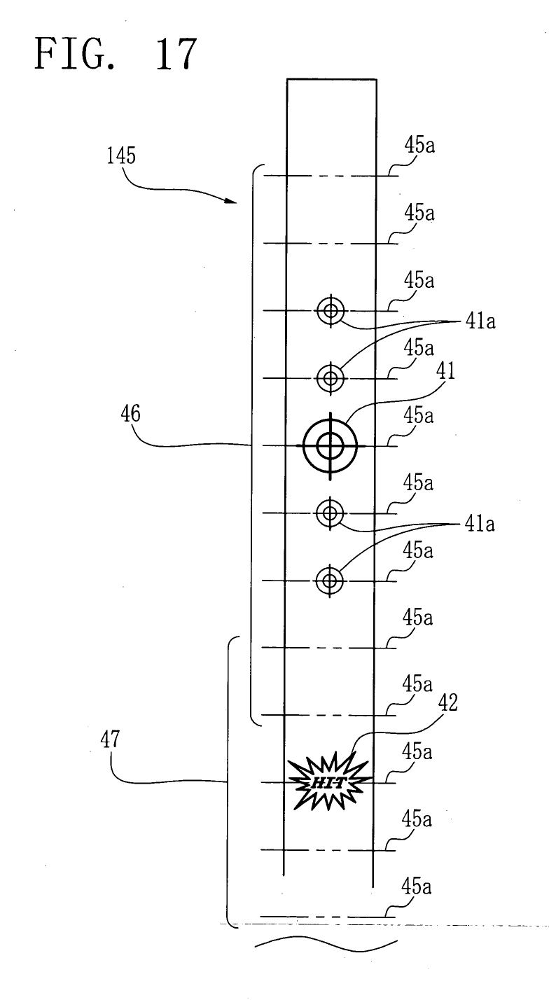

The above embodiment is described by providing five winning lines; however, it is possible to provide less than five or more than six winning lines. Referring to FIG. 16, when providing more than six winning lines, for instance, nine winning lines can be provided in total by adding the winning lines 103, 105, 107, and 109 (as shown in broken lines) to five winning lines used in the above embodiment.

The types of the win and the number of the dividend coins can be established freely. As for the types of the win, the winning combinations of both symbols and composite symbols can be established in addition to the above-mentioned winning combinations. The number of dividend coins is also determined freely. For instance, it is possible to make a difference between the dividend coins of symbol combination and that of composite symbol combination. It is also possible to set the higher dividend coins when the same composite symbols are aligned in a row in the winning lines.

In the above embodiment, two games, the normal game and the special game, are described. In addition, it is possible to provide a free game that can be played for predetermined times without inserting the coins, or a bonus game with higher dividend coins or higher rate of winning. The game can be shifted to the free game or the bonus game according to the type of the win.

The types, the number, and the sequence of the symbols disposed in the symbol sheet or the transparent sheet can be changed. Different symbol sheet, or different transparent sheet can be applied to the first, the second, and the third reel units respectively.

In the above embodiment, only one type of winning symbol is described. However, plural kinds of winning symbols can be provided. In that case, a transparent sheet 145 provided with two types of winning symbols, “target” 41 and “half target” 41a, can be used (See FIG. 17). Two types of composite symbols, one formed with the symbol “target” 41 and the other formed with the symbol “half target” 41a, are related to the win. Thus, it becomes possible to increase the types of composite signals and the winning symbol combinations by providing plural winning symbols. As a result, the game raises more interest of the player.

In the above embodiment, sections without the symbols n the outer reel are formed as transparent blank sections. However, it is possible to make the blank section lightproof. In that case, transparent section is made on the periphery of the symbol, since the inner reel cannot be observed through the blank section. It attracts more interest from the player by restricting the area through which the inner reel is observed.

In the above embodiment, each reel is stopped to display at least a symbol in each winning line in the display window. However, it is possible to stop each reel in a position where no symbols are displayed in the display window by creating blank sections with more than three stop lines above and below each symbol.

It is not necessary to start and stop the rotation of the first, the second, and the third reel units concurrently. For instance, the rotation of the first, the second, and the third reel units may start concurrently, but each reel can be stopped in sequence after a predetermined time. Further, it is possible to provide a reel stop button in each reel of first, second, and third reel unit units so as to stop each reel by operating the reel stop button.

The rotational speed of the inner and the outer reels can be set freely. For instance, the rotational speed of the outer reel is set at a low speed in the normal game, and is set at a high speed in the special game. Thereby, the symbols in the inner reel can be easily observed even if the symbol “target” fluctuates. In the special game, the display window can change the display quickly from the symbol “SNIPER SHOT” to the symbol “target” so as to prevent the player from being annoyed by a slow game.

The timing to stop the inner and the outer reels after the start of the normal game can be set freely. An interval between the stop of the inner reel and that of the outer reel can be also set freely.

In the above embodiment, the outer reel is rotated to fluctuate the symbol “target” within the display window. The amplitude of the rotation can be set freely. Further, it is not necessary to rotate the outer reel in a constant rhythm. The rotation rhythm is changeable. The rotational pattern, which is determined by the amplitude and the rhythm of the rotation, is also set freely. Further, it is also possible to control the rotation of the inner reel to fluctuate the symbols in the inner reel, or the rotation of both inner and outer reels to fluctuate the symbols in both reels.

In the above embodiment, all reel units (the first, the second, and the third reel) are the double reels having the inner and the outer reels. However, the number of the double reels, or the location of such reels can be properly changed.

In the above embodiment, the winning symbols are disposed in the outer reel. However, it is possible to dispose the winning symbols in the inner reel. In that case, it is preferable to make the winning symbols easy to observe by forming the winning symbols in the inner reel larger, or by providing transparent sections in the symbols in the outer reel.

In the above embodiment, the stop positions of the symbols disposed in the inner and outer reels are decided at first, and then win or loss of the game and the type of win or loss are decided according to the symbol or the composite symbol combinations that are disposed in the decided stop positions. However, it is possible to decide win or loss of the game and the type of win or loss at first, and then stop the inner and the outer reels to display the decided symbol or the composite symbol combination according to the decision.

Although the present invention has been described with respect to the preferred embodiments, the present invention is not to be limited to the above embodiments but, on the contrary, various modifications will be possible to those skilled in the art without departing from the scope of claims appended hereto.

1. A symbol display device, for a game machine, that determines win or loss of a game according to symbol combinations displayed in a display window, said symbol display device comprising:
plural reel units rotatably aligned in a row behind said display window, each of said plural reel unit being provided with symbols, at least one of said plural reel units being double reels including an inner reel and a transparent outer reel;
a winning symbol provided on a first reel that is one reel of said inner reel and said outer reel, said winning symbol forms a composite symbol by overlaying said winning symbol on said symbol provided on a second reel that is the other reel of said inner and outer reels; and
a controller for controlling rotation of said plural reel units, said controller controls said first reel to stop after rotating in a normal and a reverse directions repeatedly within a range that said winning symbol is displayed in said display window before win or loss of said game is determined.

2. A symbol display device as recited in claim 1, wherein said first reel stops the rotation after said second reel stops the rotation.

3. A symbol display device as recited in claim 1, wherein said winning symbol is provided in the second reel.

4. A symbol display device as recited in claim 3, wherein said controller controls rotation of the second reel to stop after rotating in said normal and said reverse directions repeatedly within a range that said winning symbol is displayed in the display window.

5. A symbol display device as recited in claim 1, further comprising:
a decoration symbol, said decoration symbol provided in the first reel;
wherein said controller rotates the first reel to overlay said decoration symbol on said symbol related to win in the second reel after said win is decided.

6. A symbol display device as recited in claim 5, wherein said decoration symbol is not displayed in said display window while the first reel repeats the rotation in said normal and said reverse directions.

7. A symbol display device as recited in claim 1, further comprising:
a shielding symbol provided in said outer reel, said shielding symbol shields a part of a symbol provided in said inner reel.

8. A symbol display device as recited in claim 7, wherein said shielding symbol is not displayed in said display window while the first reel repeats the rotation in said normal and said reverse directions.

9. A symbol display device as recited in claim 1,
wherein plural zones are provided in outer periphery of said first reel;
wherein said controller controls the rotation of said first reel such that only one of said plural zones is displayed through said display window, and changes a zone to be displayed in said display window according to a game stage.

10. A symbol display device as recited in claim 9,
wherein one of said plural zones is a win/loss determining zone consisting essentially of said winning symbol and non-symbol area;
wherein said controller rotates said first reel in said normal and said reverse directions in a range that only said win/loss determining zone is displayed in said display window.

11. A symbol display device, for a game machine, that determines win or loss of a game according to symbol combinations displayed in a display window, said symbol display device comprising:
plural reel units rotatably aligned in a row behind said display window, each of said plural reel unit being provided with symbols thereof, at least one of said plural reel units being double reels including an inner reel and a transparent outer reel;
a winning symbol provided on a first reel that is one reel of said inner reel and said outer reel, said winning symbol forms a composite symbol by overlaying said winning symbol on said symbol provided on a second reel that is the other reel of said inner and said outer reels; and
a controller for controlling rotation of said plural reel units, said controller controls said first reel to stop after rotating in a normal and a reverse directions repeatedly within a range that said winning symbol is displayed in said display window.

12. A symbol display device as claimed in claim 11, wherein plural zones are provided on outer periphery of said first reel;
wherein said controller controls the rotation of said first reel such that only one of said plural zones is displayed through said display window, and changes a zone to be displayed in said display window according to a game stage.

13. A symbol display device as claimed in claim 12, wherein one of said plural zones is a win/loss determining zone consisting essentially of said winning symbol and non-symbol area;
wherein said controller rotates said first reel in said normal and said reverse directions in a range that only said win/loss determining zone is displayed in said display window.
